(19) United States
(12) Patent Application Publication
(10) Pub. No.: US 2020/0298737 A1
(43) Pub. Date: Sep. 24, 2020

(54) MULTI-PLANAR UPHOLSTERY FASTENER FOR SEATING ASSEMBLY

(71) Applicant: Ford Global Technologies, LLC, Dearborn, MI (US)

(72) Inventor: Robert Charles Shipley, Plymouth, MI (US)

(73) Assignee: Ford Global Technologies, LLC, Dearborn, MI (US)

(21) Appl. No.: 16/357,956

(22) Filed: Mar. 19, 2019

(51) Int. Cl. B60N 2/58; B60N 2/70

(52) U.S. Cl. CPC B60N 2/5833; B60N 2/70

(57) ABSTRACT

A fastener for coupling upholstery with padding of a seating assembly is provided. The fastener includes a plurality of elongated members. The plurality of elongated members includes a base member and one or more wing members. A plurality of flexible arms extends between two or more of the plurality of elongated members. The plurality of flexible arms operably couples the one or more wing members with the base member. A plurality of retention features extends outward from each of the plurality of elongated members. The plurality of retention features is configured to engage with a looped material.

### FIELD OF THE DISCLOSURE

The present disclosure generally relates to an upholstery fastener for a seating assembly, more specifically to an upholstery fastener for a seating assembly for a vehicle.

### BACKGROUND OF THE DISCLOSURE

Current fastener designs for coupling upholstery with cushions of a vehicle seating assembly include fasteners that are positioned along the cushion. Many current fastener designs cover only a singular geometric planar surface for adhesion. Because the fasteners only cover a single plane, the fasteners may fail to provide enough surface area for adhesion of the upholstery to the fasteners to fully secure the upholstery to the cushion.

### SUMMARY OF THE DISCLOSURE

According to one aspect of the present disclosure, a fastener for coupling upholstery with padding of a seating assembly is provided. The fastener may include a plurality of elongated members. The plurality of elongated members may include a base member and one or more wing members. A plurality of flexible arms may extend between two or more of the plurality of elongated members. The plurality of flexible arms may operably couple the one or more wing members with the base member. A plurality of retention features may extend outward from each of the plurality of elongated members. The plurality of retention features may be configured to engage with a looped material.

Embodiments of this aspect of the disclosure can include any one or a combination of the following features:
the one or more wing members including a first wing member and a second wing member, the first wing member positioned laterally opposing the second wing member;
the one or more wing members oriented perpendicular to the base member;
the plurality of flexible arms interspaced along an edge of the base member and an edge of one wing member; and/or
each of the plurality of retention features including an engagement portion, the engagement portion extending at least partially parallel with the respective elongated member.

According to another aspect of the present disclosure, a fastener assembly for a seating assembly is provided. The fastener assembly may include a plurality of fasteners positioned within a cavity defined by padding. Each of the plurality of fasteners may include a plurality of elongated members. A plurality of arms may extend between two or more of the plurality of elongated members. A plurality of retention features may be positioned on each of the plurality of elongated members. The plurality of retention features may be configured to engage with a looped material. A connection member may extend between one or more of the plurality of fasteners.

Embodiments of this aspect of the disclosure can include any one or a combination of the following features:
the plurality of elongated members including a base member positioned between first and second wing members;
each of the plurality of retention features positioned on the first and second wing members extending outward from the respective wing member and toward the base member;
the connection member being flexible, wherein the plurality of fasteners and the connection member form a flexible chain of fasteners; and/or
each of the plurality of fasteners positioned within a cavity defined by padding, wherein each of the plurality of fasteners is operably coupled to an inner wall of the cushion.

According to another aspect of the present disclosure, a seating assembly is provided. The seating assembly may include padding operably coupled to one of a seat base and a seatback. The cushion may include an inner wall at least partially defining a cavity. Upholstery may be operably coupled to the cushion. A fastener may be positioned within the cavity of the cushion. The fastener may include a plurality of elongated members positioned along the inner wall. The plurality of elongated members may include a base member, a first wing member, and a second wing member. A flexible arm may extend between two or more of the plurality of elongated members. A plurality of retention features may extend outward from each of the plurality of elongated members.

Embodiments of this aspect of the disclosure can include any one or a combination of the following features:
the inner wall including a bottom wall and a sidewall;
the base member operably coupled to the bottom wall and one of the first wing member and the second wing member is coupled to the sidewall;
the cavity extending from a first end of the cushion to a second end of the cushion;
the cavity having a substantially rectangular cross-section, and further wherein the cavity is in communication with an opening defined by a top surface of the cushion;
the upholstery including a looped material coupled to a lower surface of the upholstery;
the upholstery coupled to the cushion such that the lower surface of the upholstery abuts the top surface of the cushion, wherein the looped material and a portion of the upholstery extends through the opening and into the cavity;
the plurality of retention features including engagement portions configured to engage with the looped material;
each of the plurality of elongated members defining a recess, wherein the plurality of retention features are positioned at least partially within the recess; and/or
each of the first and second wing members being movable between a first position and a second position to complement a cross-sectional shape of the cavity.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a side perspective view of a seating assembly within a vehicle, according to various examples;

FIG. 2 is a side perspective view of the seating assembly of FIG. 1 removed from the vehicle and including a cut-away view of padding beneath upholstery;

FIG. 3 is a cross-sectional view taken along line of FIG. 2 showing padding for the seating assembly of FIG. 1 including a fastener;

FIG. 4 is a top perspective view of the fastener of FIG. 3, according to various examples;

FIG. 4A is an enlarged view of the fastener of FIG. 4;

FIG. 4B is a top perspective view of the fastener of FIG. 3 showing various positions of the fastener;

FIG. 5 is a top profile view of a plurality of fasteners, according to various examples;

FIG. 6 is a cross-sectional view of a fastener coupled to a mold for padding, according to various examples; and

FIG. 7 is a cross-sectional view of the fastener and the cushion of FIG. 6 with the mold removed.

### DETAILED DESCRIPTION OF THE PREFERRED EMBODIMENTS

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises” does not, without more constraints, preclude the existence of additional identical elements in the process, method, article, or apparatus that comprises the element.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The following disclosure generally describes an upholstery fastener for a vehicle seating assembly. The fastener may be positioned within a cavity defined by padding of the seating assembly. The fastener may include a plurality of elongated members, including a base member and at least one wing member. An arm may be configured to couple the base member with the wing member. The arm may be one of a plurality of arms. Each arm may also be flexible to allow movement of the wing member between a first position and a second position. A plurality of retention features may be positioned on one or more of the plurality of elongated members. The retention features may be configured to engage with a looped material positioned on a lower surface of upholstery for the seating assembly. When the upholstery is inserted within the cavity, the looped material engages with the retention features, coupling the upholstery with the cushion. The fastener having the base member and at least one wing member provides an improved grip as compared to fasteners with only the base member.

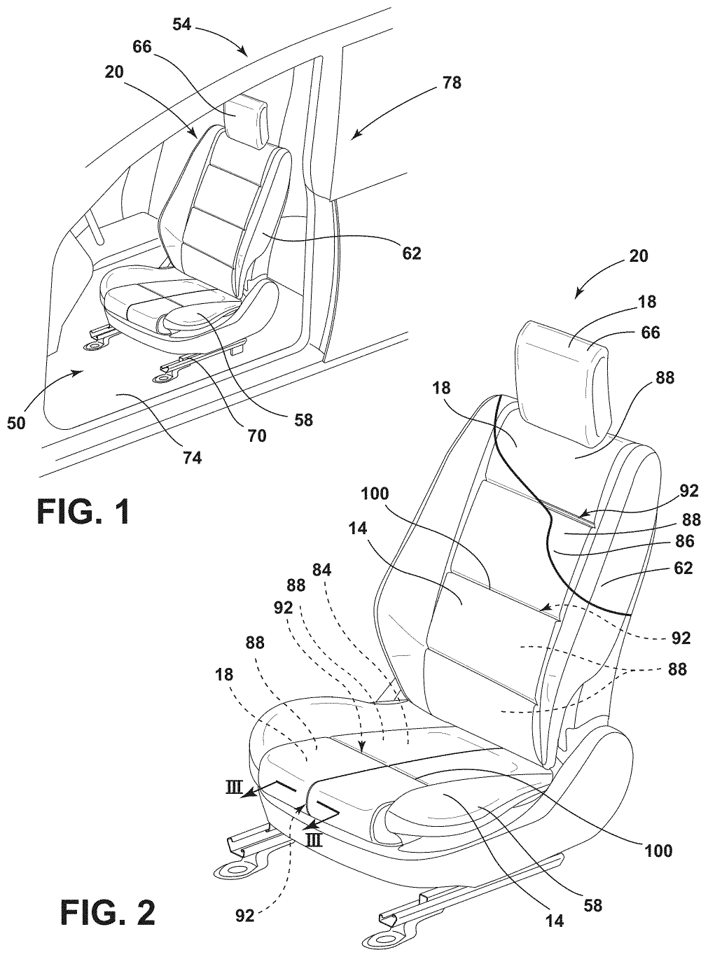

Referring now to FIGS. 1-7, reference numeral 10 generally designates a fastener for coupling upholstery 14 with padding 18 of a vehicle seating assembly 20. The fastener 10 may include a plurality of elongated members 24, 26, 28. The plurality of elongated members 24, 26, 28 may include a base member 24 and one or more wing members 26, 28. A plurality of flexible arms 32 may extend between two or more of the plurality of elongated members 24, 26, 28. The plurality of flexible arms 32 may operably couple the one or more wing members 26, 28 with the base member 24. A plurality of retention features 36 may extend outward from each of the plurality of elongated members 24, 26, 28. The plurality of retention features 36 may be configured to engage with a looped material 40.

Referring now to FIG. 1, the seating assembly 20 is shown disposed within a front portion 50 of a vehicle 54. The seating assembly 20 includes a seat base 58 and a seatback 62 and may include a headrest 66. In various examples, the seating assembly 20 may be coupled to a track assembly 70 positioned within the vehicle 54. In other examples, the seating assembly 20 may be coupled to a floor 74 of the vehicle 54. It will be understood that the seating assembly 20 may be coupled to a plurality of tracks, a swivel plate, a pitching mechanism, a platform, or any other feature(s) configured to couple the seating assembly 20 with the vehicle 54 without departing from the scope of the present disclosure. It is contemplated that the vehicle 54 may be any type of vehicle, such as a car, a truck, a van, etc. It is also contemplated that the concept set forth in this disclosure may be utilized in the front portion 50 of the vehicle 54, as well as in a rear portion 78 of the vehicle 54, depending on the configuration of the vehicle 54.

Referring now to FIG. 2, the padding 18 may be positioned on the seating assembly 20, including the seat base 58, the seatback 62, the headrest 66, or any other portion of the seating assembly 20. The padding 18 may be a foam material, a polyester material, or any other material configured to support and provide comfort for an occupant of the seating assembly 20. The padding 18 may include at least one seat base cushion 84 and at least one seatback cushion 86. The seat base cushion 84 may be divided into a plurality of sections 88 by retention trenches 92. Each of the retention trenches 92 may extend from a first side of the seat base cushion 84 to a second side of the seat base cushion 84. In various examples, the retention trenches 92 may extend laterally across the seat base cushion 84. In other examples, the retention trenches 92 may extend longitudinally across the seat base cushion 84. Likewise, the seatback cushion 86 may be divided into a plurality of sections 88 by retention trenches 92. Each of the retention trenches 92 may extend from a first side of the seatback cushion 86 to a second side of the seatback cushion 86. In various examples, the retention trenches 92 may extend laterally across the seatback cushion 86. In other examples, the retention trenches 92 may extend longitudinally across the seatback cushion 86. It is contemplated that the padding 18 may also include padding 18 positioned on the headrest 66, laterally of the seat base cushion 84, or laterally of the seatback cushion 86. It is also contemplated that any of the padding 18 may include retention trenches 92. Further, it is contemplated that the seating assembly 20 may be any type of seating assembly 20 not limited to the exemplary seating assembly 20 illustrated in FIGS. 1 and 2.

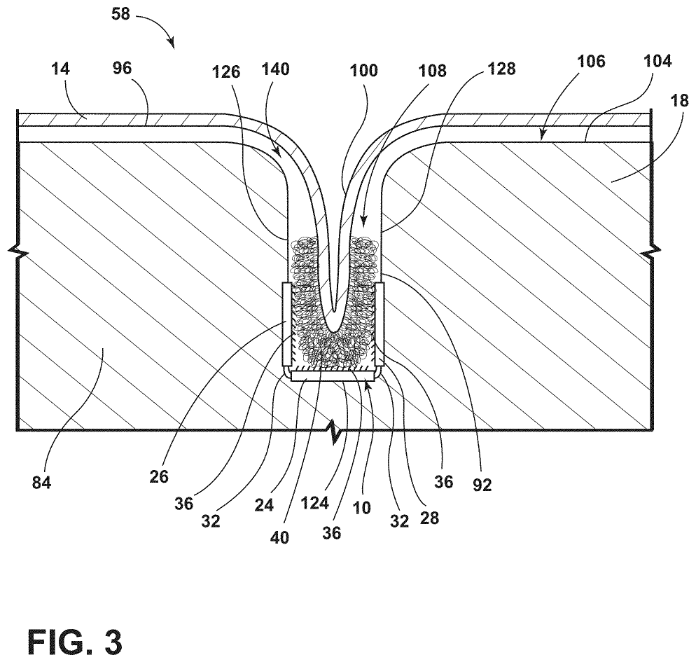

Referring now to FIGS. 2 and 3, the upholstery 14 may be positioned over the padding 18. The upholstery 14 may include a lower surface 96 positioned to contact a top surface 104 of the padding 18. In other examples, the upholstery 14 may be positioned so that the lower surface 96 is substantially parallel with and spaced apart from the top surface 104 of the padding 18. A space 106 may be defined between the upholstery 14 and the padding 18. The space 106 may be configured to house other layers of padding, heating layers, trim layers, or any other layer or layers of the seating assembly 20. In still other examples, the space 106 may be negligible such that the lower surface 96 of the upholstery 14 is substantially flush with the top surface 104 of the padding 18.

The looped material 40 may be coupled to the lower surface 96 of the upholstery 14. Alternatively, the looped material 40 may be integrally formed with the lower surface 96 of the upholstery 14. The looped material 40 is positioned on the lower surface 96 of the upholstery 14 such that the looped material 40 is oriented between the upholstery 14 and the padding 18. The looped material 40 may be threads, fabric, or any other material or materials defining looped portions. In various examples, the looped material 40 may be positioned across the lower surface 96 of the upholstery 14 along a seam 100 configured to align with one of the retention trenches 92. In other examples, the looped material 40 may be positioned across a substantial portion of the lower surface 96 of the upholstery 14. In still other examples, the looped material 40 may be positioned across the entirety of the lower surface 96 of the upholstery 14.

The upholstery 14 may be operably coupled to one or more of the padding 18 by at least one fastener 10 positioned within a cavity 108 defined by the padding 18. Where the upholstery 14 is coupled to the padding 18 by the fastener 10, the upholstery 14 may extend into the cavity 108, as discussed elsewhere herein. When the upholstery 14 is positioned at least partially within the cavity 108, the looped material 40 may be engaged with the fastener 10 to couple the upholstery 14 with the padding 18. It will be understood that the upholstery 14 may be fabric, leather, or any other material for covering the seating assembly 20.

Referring now to FIG. 3, a cross-sectional view of one of the retention trenches 92 of the seat base cushion 84 is shown. The configuration may apply to any portions of the padding 18. The retention trench 92 may have inner walls 124, 126, 128. The inner walls may include a bottom wall 124, a first sidewall 126, and a second sidewall 128. According to various examples, the first and second sidewalls 126, 128 may be oriented perpendicularly to the bottom wall 124. In other examples, the first and second sidewalls 126, 128 may be positioned at an incline relative to the bottom wall 124.

The inner walls 124, 126, 128 of the retention trench 92 may define the cavity 108. The cavity 108 may be defined along at least a portion of the retention trench 92. As discussed elsewhere herein, the retention trench 92 may extend from the first side of the seat base cushion 84 to the second side of the seat base cushion 84. The cavity 108 may likewise be defined from the first side of the seat base cushion 84 to the second side of the seat base cushion 84. Where the first and second sidewalls 126, 128 are perpendicular to the bottom wall 124, the inner walls 124, 126, 128 of the retention trench 92 may define the cavity 108 having a substantially rectangular cross-section.

The top surface 104 of the seat base cushion 84 and the retention trench 92 may at least partially define an opening 140 in communication with the cavity 108. The opening 140 may be elongated and may extend in tandem with the cavity 108 from the first end of the seat base cushion 84 to the second end of the seat base cushion 84. Where the first and second sidewalls 126, 128 are perpendicular to the bottom wall 124, a width of the opening 140 and the cavity 108 may be substantially constant. Where the first and second sidewalls 126, 128 are inclined inward toward the bottom wall 124, the width of the opening 140 and the cavity 108 may increase from the opening 140 toward the bottom wall 124 of the retention trench 92. Where the first and second sidewalls 126, 128 are inclined outward away from the bottom wall 124, the width of the opening 140 and the cavity 108 may decrease from the opening 140 toward the bottom wall 124. It will be understood that any width or combination of widths may be used without departing from the scope of the present disclosure.

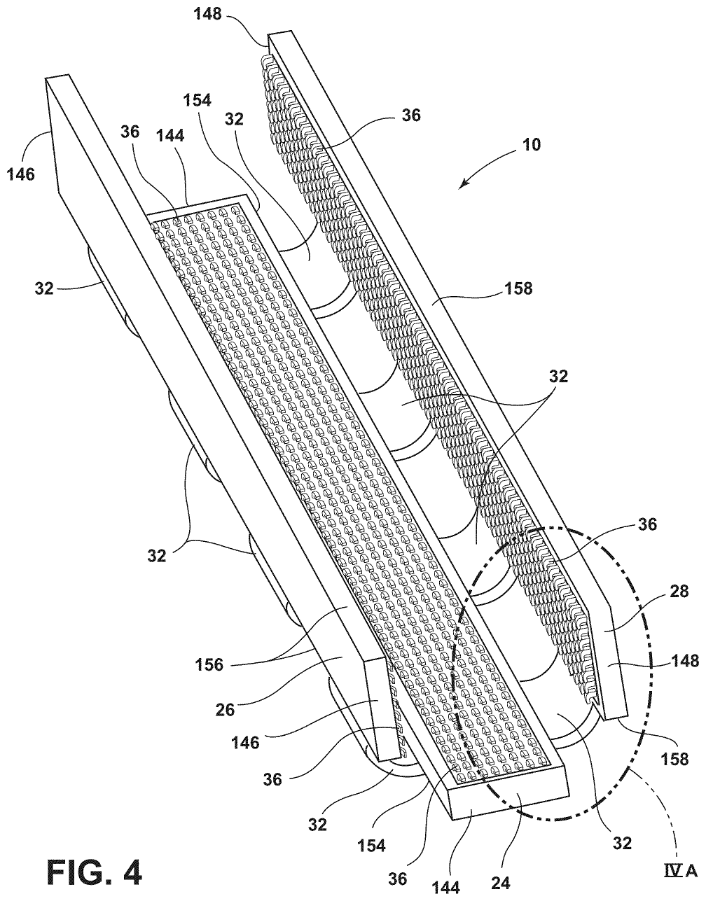

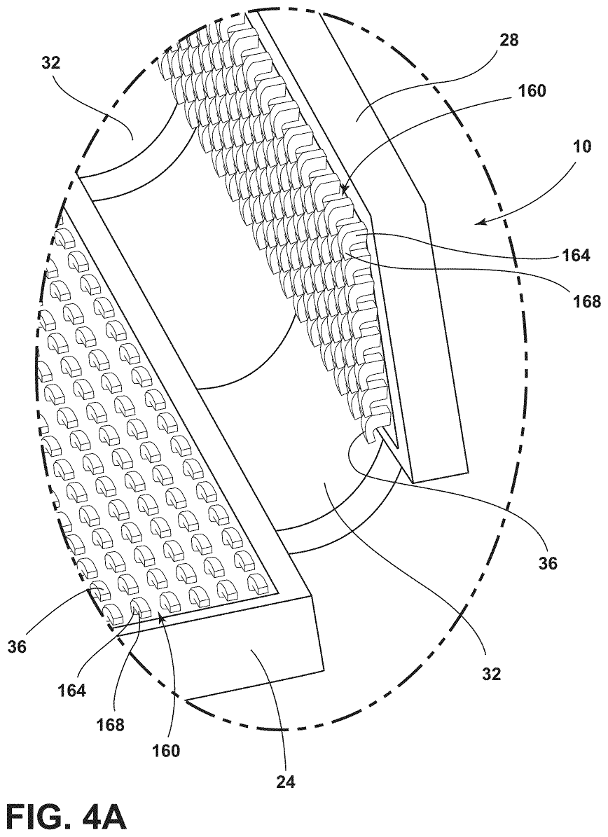

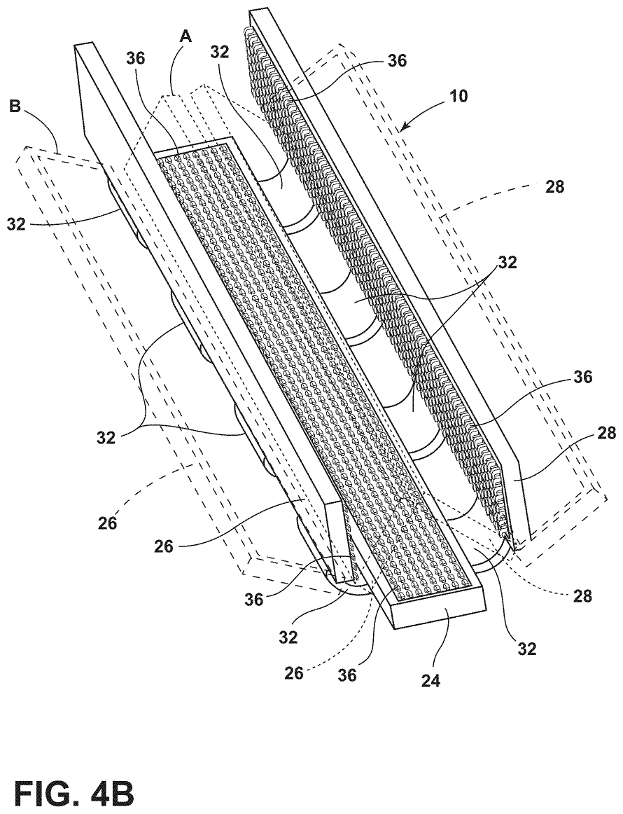

Referring now to FIGS. 3 and 4, the fastener 10 is shown positioned within the cavity 108 of the padding 18 (FIG. 3) and removed from the cavity 108 of the padding 18 (FIG. 4). The fastener 10 may include a plurality of elongated members 24, 26, 28. Each of the plurality of elongated members 24, 26, 28 may have a pair of ends 144, 146, 148 and a pair of edges 154, 156, 158, respectively. The ends 144, 146, 148 may be shorter or the same length as the edges 154, 156, 158. The plurality of elongated members 24, 26, 28 may include the base member 24 and one or more wing members 26, 28, as discussed elsewhere herein. The one or more wing members 26, 28 may include a first wing member 26 and a second wing member 28.

As shown in FIG. 4, the first wing member 26 may be positioned proximate and coupled to one of the pair of edges 154 of the base member 24. The second wing member 28 may be positioned proximate and coupled to the other, laterally opposing edge 154 of the pair of edges 154 of the base member 24. In other words, the first wing member 26 may be positioned laterally opposing the second wing member 28. According to various examples, each of the plurality of elongated members 24, 26, 28 may have a generally rectangular shape. Where the plurality of elongated members 24, 26, 28 have a generally rectangular shape, each pair of ends 144, 146, 148 may be positioned perpendicular to the respective pair of edges 154, 156, 158. In other examples, each of the plurality of elongated members 24, 26, 28 may have a generally oblong shape. Where the plurality of elongated members 24, 26, 28 have a generally oblong shape, each of the pairs of ends 144, 146, 148 may be at least partially nonlinear or rounded. In still other examples, each of the plurality of elongated members 24, 26, 28 may have any other shape configured to complement the shape of the retention trench 92 of the padding 18. It is contemplated that each of the plurality of elongated members 24, 26, 28 may have a different shape from the rest of the plurality of elongated members 24, 26, 28. Each of the plurality of elongated members 24, 26, 28 may define a recess 160 (FIG. 4A). Each recess 160 may be shaped to complement the overall shape of the respective elongated member 24, 26, 28.

As shown in FIG. 3, the plurality of elongated members 24, 26, 28 may be positioned along the inner walls 124, 126, 128 of the cavity 108 of the padding 18. The plurality of elongated members 24, 26, 28 may be coupled to the inner walls 124, 126, 128 of the cavity 108 of the padding 18, as discussed elsewhere herein. The base member 24 may be operably coupled to the bottom wall 124 of the cavity 108 of the padding 18. Similarly, the first wing member 26 and the second wing member 28 may be coupled to first and second sidewalls 126, 128.

Referring now to FIGS. 4 and 4A, the plurality of retention features 36 may be positioned on one or more of the plurality of elongated members 24, 26, 28. Each of the plurality of retention features 36 may be positioned at least partially within the recess 160 of the respective elongated member 24, 26, 28. A base portion 164 of each of the plurality of retention features 36 is coupled with the respective elongated member 24, 26, 28. The base portion 164 extends outward from the elongated member 24, 26, 28 and may be integrally formed with an engagement portion 168. The engagement portion 168 may be positioned substantially perpendicular to the base portion 164 and may include a rounded corner or a linear corner. In various examples, the engagement portion 168 of each of the plurality of retention features 36 may curve back towards the respective elongated member 24, 26, 28 in a hook shape. In other examples, the engagement portion 168 of each of the plurality retention features 36 may be positioned to extend towards one of the pair of ends 144, 146, 148 of the respective elongated member 24, 26, 28. In still other examples, the engagement portion 168 of each of the plurality of retention features 36 may be positioned to extend towards one of the pair of edges 154, 156, 158 of the respective elongated member 24, 26, 28. The plurality of retention features 36 of the base member 24 may include more than one engagement portion 168 to define a two-pronged retention feature 36, in various examples. In other examples, the plurality of retention features 36 of the base member 24 may be omni-directional and extend in any number of directions.

In some examples, the engagement portion 168 of each of the plurality of retention features 36 positioned on the first wing member 26 and the second wing member 28 may be configured to extend in the same direction (e.g., towards the base member 24, away from the base member 24). Where the plurality of retention features 36 of the first and second wing members 26, 28 extend toward the base member 24, the direction of the plurality of retention features 36 allows for insertion of the upholstery 14 and loop material 40 into the cavity 108 to couple the upholstery 14 to the padding 18 without engaging the plurality of retention features 36 of the first and second wing members 26, 28 with the loop material 40 prior to the loop material 40 engaging with the plurality of retention features 36 of the base member 24. The engagement of the loop material 40 with the plurality of retention features 36 located on the base member 24 prior to engaging the plurality of retention features 36 on the first and second wing members 26, 28 may improve retention of the loop material 40 with the fastener 10 within the cavity 108 while preventing premature hook-to-loop engagement.

As shown in FIGS. 3-4A, according to various examples, the plurality of retention features 36 may be positioned along each of the elongated members 24, 26, 28 in a plurality of columns and/or a plurality of rows. In other examples, the plurality retention features 36 may be positioned in offset rows. In still other examples, the plurality of retention features 36 may be positioned in any configuration, including various patterns and non-uniform configurations. Each of the plurality of retention features 36 may be one size or different sizes, depending on the configuration of the plurality of retention features 36. As discussed elsewhere herein, each of the plurality of retention features 36 may be configured to engage with the looped material 40 positioned on the lower surface 96 of the upholstery 14. The engagement portions 168 of each of the plurality of retention features 36 may be configured as hooks or hook-shaped members to hook to, or otherwise be received by, one or more of the loops of the looped material 40 (e.g., Velcro®).

Referring now to FIGS. 4 and 4B, the plurality of arms 32 may extend between two or more of the plurality of elongated members 24, 26, 28. For example, an arm 32 may extend between one of the pair of edges 154 of the base member 24 and the proximate edge 156 of the first wing member 26. Any number of arms 32 may be used, such as, for example, using one arm 32 to couple the base member 24 to the first wing member 26 and a second arm 32 to couple the base member 24 to the second wing member 28. In other words, the plurality of arms 32 may operably couple the first and second wing members 26, 28 with each of the pair of edges 154 of the base member 24, respectively. A default position of each of the plurality of arms 32 may be configured to orient one of the first wing member 26 and the second wing member 28 substantially perpendicular with base member 24. The plurality of arms 32 may be flexible such that the plurality of arm 32 may allow the first and second wing members 26, 28 to move between a first position A and a second position B, as shown in FIG. 4B. The flexibility of the plurality of arms 32 allows the fastener 10 to be adjusted to complement the shape of the cavity 108 (see FIG. 3). When each of the plurality of flexible arms 32 is positioned such that the first and second wing members 26, 28 are in the first position A, the first and second wing members 26, 28 may be inclined toward the base member 24. When each of the plurality of flexible arms 32 is positioned such that the first and second wing members 26, 28 are in the second position B, the first and second wing members 26, 28 may be inclined away from and outward of the base member 24.

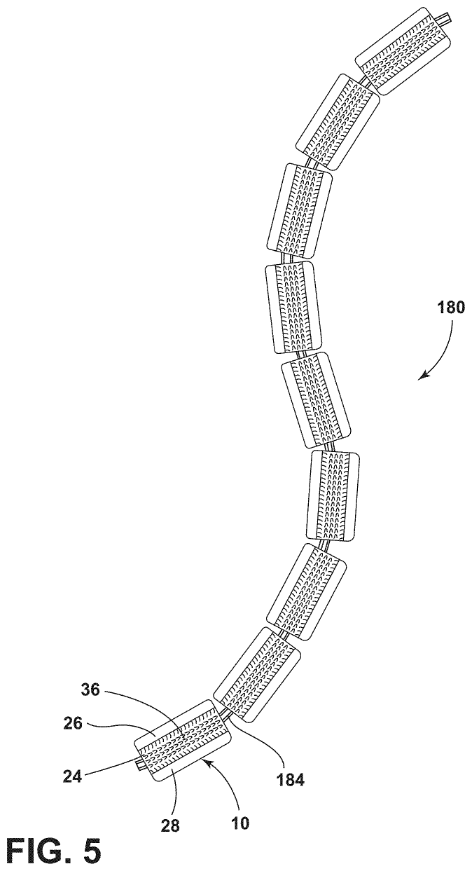

Referring now to FIGS. 3 and 5, the fastener 10 may be one of a plurality of fasteners 10. The plurality of fasteners 10 may be positioned within the cavity 108 of the retention trench 92 of the padding 18. The plurality of fasteners 10 may include any number of fasteners 10. The fasteners 10 may be spaced apart by a predetermined spacing. The spacing may be constant across the plurality of fasteners 10. Alternatively, the spacing may be varied. Each of the fasteners 10 may be the same or different sizes. In various examples, the plurality of fasteners 10 may be individually positioned within the cavity 108. In other examples, the plurality of fasteners 10 may be interconnected to form a flexible chain of fasteners 180, as shown in FIG. 5. Each of the fasteners 10 may be interconnected by connection members 184 extending from the base member 24 of each fastener 10 to the base member 24 of the neighboring fastener 10. The connection members 184 may be positioned in pairs between the fasteners 10 and may be flexible to provide maneuverability of the chain of fasteners 180. Each of the connection members 184 may be selected and sized to provide predetermined spacing between each of the fasteners 10.

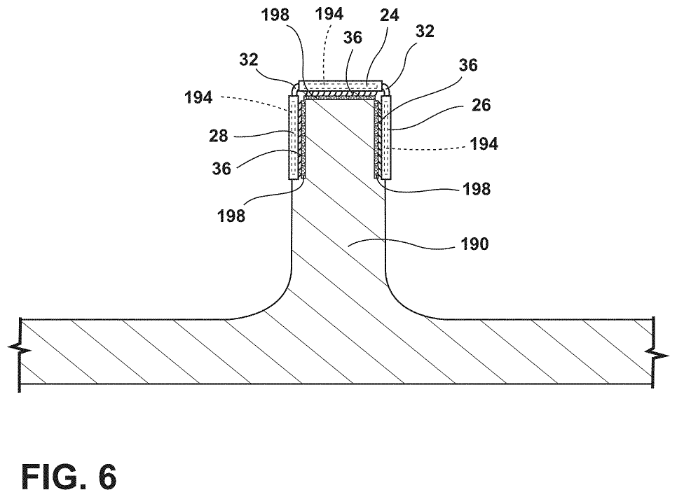

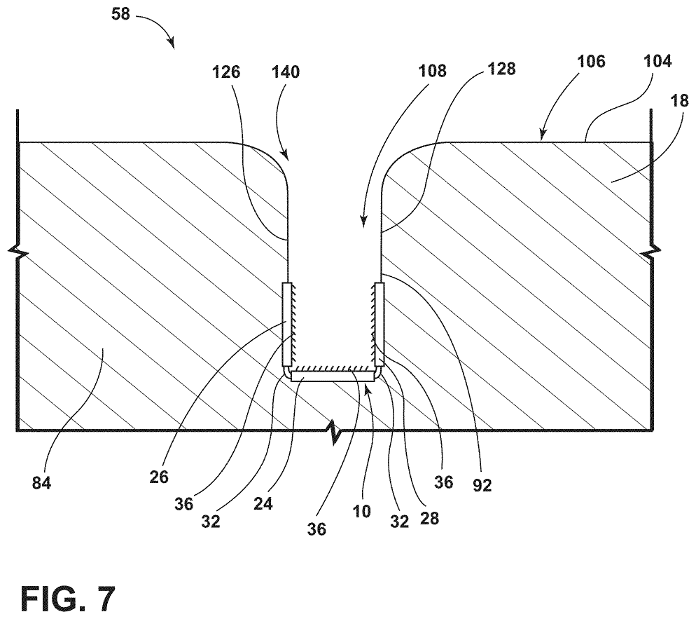

Referring now to FIGS. 6 and 7, each fastener 10 may be integrally formed with inner walls 124, 126, 128 of the retention trench 92 of the padding 18 using a mold tool 190. The mold tool 190 may be configured to form the retention trench 92 of the padding 18 and to subsequently define the cavity 108 and corresponding opening 140. One or more of the plurality of elongated members 24, 26, 28 of the fastener 10 may include a metallic material 194. The metallic material 194 may extend along at least a portion of the respective elongated member 24, 26, 28. The metallic material 194 may be configured to engage with magnets 198 positioned on the mold tool 190. When the metallic material 194 engage with the magnets 198 of the mold tool 190, the fastener 10 is secured to the mold tool 190. Once the fastener 10 is secured to the mold tool 190, a foam material, or other soft polymer material, may be poured to form the padding 18. The mold tool 190 may be used with any mold configured to form padding 18 and may be removed once the padding 18 has been formed. When the mold tool 190 is removed, the fastener 10 remains embedded within, and coupled to, the foam of the padding 18 and positioned within the cavity 108.

It will be understood by one having ordinary skill in the art that construction of the described concepts, and other components, is not limited to any specific material. Other exemplary embodiments of the concepts disclosed herein may be formed from a wide variety of materials unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the system may be varied, and the nature or numeral of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes, or steps within described processes, may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further, it is to be understood that such concepts are intended to be covered by the following claims, unless these claims, by their language, expressly state otherwise.

What is claimed is:

1. A fastener for coupling upholstery with padding of a seating assembly, comprising:
a plurality of elongated members comprising a base member and one or more wing members;
a plurality of flexible arms extending between two or more of the plurality of elongated members, wherein the plurality of flexible arms operably couples the one or more wing members with the base member; and
a plurality of retention features extending outward from each of the plurality of elongated members, the plurality of retention features configured to engage with a hook or a looped material.

2. The fastener of claim 1, wherein the one or more wing members includes a first wing member and a second wing member, the first wing member positioned laterally opposing the second wing member.

3. The fastener of claim 1, wherein the one or more wing members are oriented perpendicular to the base member.

4. The fastener of claim 1, wherein the plurality of flexible arms are interspaced along an edge of the base member and an edge of one wing member.

5. The fastener of claim 1, wherein each of the plurality of retention features includes an engagement portion, the engagement portion extending at least partially parallel with the respective elongated member.

6. A fastener assembly for a seating assembly, comprising:
a plurality of fasteners positioned within a cavity defined by padding, wherein each of the plurality of fasteners comprises:
a plurality of elongated members;
a plurality of arms extending between two or more of the plurality of elongated members; and
a plurality of retention features positioned on each of the plurality of elongated members, the plurality of retention features configured to engage with a hook or a looped material; and
a connection member extending between one or more of the plurality of fasteners.

7. The fastener assembly of claim 6, wherein the plurality of elongated members includes a base member positioned between first and second wing members.

8. The fastener assembly of claim 7, wherein each of the plurality of retention features positioned on the first and second wing members extends outward from the respective wing member and toward the base member.

9. The fastener assembly of claim 6, wherein the connection member is flexible, and further wherein the plurality of fasteners and the connection member form a flexible chain of fasteners.

10. The fastener assembly of claim 6, wherein each of the plurality of fasteners is positioned within a cavity defined by padding, and further wherein each of the plurality of fasteners is operably coupled to an inner wall of the cushion.

11. A seating assembly, comprising:
padding operably coupled to one of a seat base and a seatback, wherein the cushion includes an inner wall at least partially defining a cavity;
upholstery operably coupled to the cushion; and
a fastener positioned within the cavity of the cushion, wherein the fastener comprises:
a plurality of elongated members positioned along the inner wall, the plurality of elongated members including a base member, a first wing member, and a second wing member;
a flexible arm extending between two or more of the plurality of elongated members; and
a plurality of retention features extending outward from each of the plurality of elongated members.

12. The seating assembly of claim 11, wherein the inner wall includes a bottom wall and a sidewall.

13. The seating assembly of claim 12, wherein the base member is operably coupled to the bottom wall and one of the first wing member and the second wing member is coupled to the sidewall.

14. The seating assembly of claim 11, wherein the cavity extends from a first end of the cushion to a second end of the cushion.

15. The seating assembly of claim 11, wherein the cavity has a substantially rectangular cross-section, and further wherein the cavity is in communication with an opening defined by a top surface of the cushion.

16. The seating assembly of claim 15, wherein the upholstery includes a looped material coupled to a lower surface of the upholstery.

17. The seating assembly of claim 16, wherein the upholstery is coupled to the cushion such that the lower surface of the upholstery abuts the top surface of the cushion, and further wherein the looped material and a portion of the upholstery extends through the opening and into the cavity.

18. The seating assembly of claim 16, wherein engagement portions of the plurality of retention features of the first and second wing members are oriented to engage with the looped material after the engagement portions of the plurality of retention features of the base member are engaged with the looped material.

19. The seating assembly of claim 11, wherein each of the plurality of elongated members defines a recess, and further wherein the plurality of retention features are positioned at least partially within the recess.

20. The seating assembly of claim 11, wherein each of the first and second wing members is movable between a first position and a second position to complement a cross-sectional shape of the cavity.
